(19) United States
(12) Patent Application Publication
(10) Pub. No.: US 2010/0276163 A1
(43) Pub. Date: Nov. 4, 2010

(54) Fiber Reinforced Polymer Horseshoe

(76) Inventors: Christopher Berghorn, Valley Stream, NY (US); Ryan McGann, Shoreham, NY (US)

Correspondence Address: Christopher Berghorn, 107 North Grove Street, Valley Stream, NY, 11580, US

(21) Appl. No.: 12/433,884

(22) Filed: Apr. 30, 2009

(51) Int. Cl. A01L 5/00

(52) U.S. Cl. 168/4

(57) ABSTRACT

A method of manufacturing custom and standard sized Fiber reinforced polymer horseshoe by utilizing vacuum molding. The specified horseshoe is produced from a mold rendered from a three dimension image, gathered by utilizing three dimensional scanning techniques, by casting a mold directly to the hoof, and or casting standard sized horseshoes. Standard sized horseshoes have set specified dimensions to which a mold can be produced from a polymer, metal, or composite. Horseshoes can be manufactured for a wide array of equine applications including horse racing, jumping, military, and law enforcement applications. Previously Fiber reinforced polymers have not been used in abrasion resistant applications, however this invention will use fiber reinforced polymers to both reduce weight of the horse shoe, and increase abrasion resistance in such a manner that cannot be met with conventional metal horseshoes.

### BACKGROUND OF THE INVENTION

In the wild horses spend a majority of their time in a constant state of motion. This dynamic state ensures proper wear and growth of the hoof of the horse. In a wild state a horse's hoof is in constant contact with the terrain below it, as a result of the terrain the hoof is allowed to naturally wear and new material allowed to grow. In a confined state such as stall living; a hose is confined to a stall (enclosure) or small turn out area. With limited space and limited movement the hose is inhibited to conduct enough necessary movements that would render natural even wearing of the hoof. Due to this confined living horses began to develop hoof issues and subsequently lameness. To combat these issues horse shoes were added.

Common horseshoes are composed of steel and aluminum. Designed to act as a protective layer between the terrain and the horses hoof, the horseshoe absorbs impact forces that would normally cause damage to the hoof walls. To secure the horseshoe to the hoof, the hoof is first trimmed to the proper geometry and measured to fit the correct size shoe. Once fitted the horseshoe is mounted to the hoof though the use of nails. Nails are driven into the keratinous region of the hoof in an upward fashion where they then penetrate the top of the hoof. Now exposed, the nail is bent in a forward fashion, cut and further hammered flat to hoof to ensure that the nail is able to free itself.

Utilizing steel and aluminum shoes has allowed for protection of the integrity of the hoof as well as the hoof walls. As a result of using such a shoe new problems arise. In its natural state the hoof acts like a shock absorber expanding and contracting as the horse takes its strides. Using metal shoes attached to the hoof restricts the flexing of the hoof, and ultimately can cause cracking and fatigue. To counteract this issue softer more flexible solid polymer based horseshoes were developed. Unlike conventional metal horseshoes that are widely accepted, solid polymer based shoes are not. This in-acceptance stems from the increased level of difficulty commonly found when trying to adhere them to the horse. Following unconventional adhesion techniques such as gluing the horseshoe to the hoof require a large amount of time and cooperation on behalf of the horse. For these reasons and more the practice of using polymer based horseshoes is not commonly practiced.

Developed in 1958 carbon fiber demonstrates a high strength to rate ratio well as a high stiffness to weight ratio. Carbon fiber is mainly composed of 80-90% amorphous carbon. Made of multiple carbon-carbon bonds, long chains emerge to form the back bone of individual carbon fibers. Spun together the individual fibers create a stronger multi-fibered yarn, yearn is then in turn used to produce a more uniform cloth like matting. This matting then able to be impregnated into a polymer matrix where by it will increase stiffness, rigidity and toughness.

Constructing a horseshoe out of a composite or fiber reinforced composite allows the designer greater ability to engineer the composite to meet detailed specifications. By utilizing a composite many of the issues once associated with prior patents can be alleviated. Where prior patents followed new conventions to adhere and secure the horseshoe to the horse the present patent follows the standard conventions, utilizing common horseshoe nails and adhesives that are widely practiced in the equine field.

### DETAILED DESCRIPTION OF THE INVENTION

The present invention relates to the equine field and its related activities. This invention more particularly relates to the production of a fiber reinforced polymer horseshoe. Utilizing materials such as carbon fiber and polymer fiber allows for increased structural rigidity and stiffness while maintaining a low overall density. This invention will be able to alleviate many problems associated with standard solid metal shoes, these problems include: increased weight on a horses' hoof, increased impact shock from metallic shoes, resulting lameness from improperly balanced shoes, among problems.

The horseshoe of the present invention is constructed from a fiber reinforced polymer FIG. 1. Fibers are added to a polymer to increase overall stiffness, improve toughness, and increase fatigue resistance over conventional polymers. Fibers used in such applications can be carbon fibers, polymer fibers, and glass fibers. Such fibers can be arranged in different orientation relative to each other to further increase rigidity. Polymers used to construct the matrix include Thermoset and Thermoplastic polymers.

Following the standard conventional design of horseshoes, the present invention contains rectangular nail holes that are extruded though the height of the horseshoe and are recessed in a fuller grove that spans the front of the horseshoe FIG. 2. In specific cases retaining tabs, known as toe clips are added to prevent the horseshoe from shifting while secured to the hoof FIG. 1. In cases where increased traction or grip is desired, small projections called calks are secured to the horseshoe through the use of recessed threaded openings on the bottom of the present horseshoe. The preferred horseshoe is manufactured by utilizing molds created from conventional sized horseshoe, or from specified dimensions obtained from three dimensional scanning techniques. Molds constructed from polymer, metal or composite are used to obtain the desired design. Placed inside the mold; fibers are adhered in layers though the use of a polymer based epoxy resin. Once the desired thickness of the horseshoe is obtained the mold containing the layered carbon fiber and epoxy matrix are placed into a sealed bag where by remaining gases are evacuated from the resin and surrounding area by a vacuum pump. As a result of being under vacuum the sealed bag applies pressure necessary to press the layers of carbon fiber and epoxy into the mold as well as expelling any unnecessary epoxy from the mold.

FIG. 1 is a horseshoe to be affixed to the horses hoof in contact with the hoof; composed of a fiber reinforced polymer composite. Reinforcing fibers that can be used are Carbon fiber, Kevlar, Carbon fiber-Kevlar hybrid fabric, and Dynel fabric to due their low density and high tensile strength. To further increase overall performance and decrease wear the fibers are layered in set orientations relative to each other.

To protect the horseshoe against excess wear a hard, durable polymer based coating is applied FIG. 6. This coating acts a protective outer shell to prevent wear from eroding the fiber structure underneath. It will also act to increase friction on hard terrain such as concrete and asphalt, consequently absorbing excess forces from impact with the terrain.

For corrective shoeing applications where it is deemed necessary to correctively adjust the hoof geometry a thick semi-hard polymer is adhered to the top of the horseshoe FIG. 10, for the ability to remove excess polymer to obtain the desired changes to realign the geometry. This horseshoe is commonly used on newborn fouls and older more feeble horses with geometry and joint issues.

To prevent the shift of a horseshoe on a horse, a horseshoe with added toe clips composed of carbon fiber or aluminum may be used FIG. 1. Toe clips aid to prevent movement or shifting of the shoe during movement or when a horse has softer than normal hooves.

To further increase traction on soft or loose ground the addition of calks may be used. To mount calks, an aluminum bottom plate is adhered to the polymer structure. This aluminum plate contains set recessed holes whereby calks may be threaded into, to secure them FIG. 7. These recessed threaded holes may also be used to attach an external polymer based impact absorbing pad.

To further secure the fiber reinforced polymer horseshoe to the hoof, an aluminum backing plate containing rectangular hollow extrusions can be used. Said hollow extrusions will act as passageways for the nails to travel through FIG. 8. Utilizing aluminum further allows for the nails to deform in the holes. As a result the horseshoe can obtain a more secure fit to the hoof.

In applications where reducing impact forces experienced by the horse is necessary, a soft elastomer based honeycomb structure can be imbedded into the structure of the horseshoe, or exist on the bottom of the horseshoe. This structure allows for calculated deformation to take place to reduce impact on contact with the ground.

In applications when forces experienced by the horses' hoof impacting the ground want to be examined and analyzed the horseshoe of the preferred invention can be produced where by sensors can be embedded in the construction of the horseshoe. These sensors can acquire data based on the forces experienced by the horse during its natural movements.

In applications such as horse racing where increased traction is desired, an elongated font spade shaped calk, spanning the front region of the horseshoe can be constructed out of carbon fiber or aluminum for the purpose of obtaining a increased level of traction of soft or loose terrain.

This invention using fiber reinforced polymers will both reduce the overall weight of the horseshoe, and increase abrasion resistance in such a manner that cannot be met with conventional metal horseshoes. This reduced weight of the horse shoe will give riders a competitive advantage over others using conventional metal horseshoes. Designed around a fiber reinforced polymer allows for the ability to tailor horseshoes based on the equine industry's needs in a more efficient manor than can be achieved over standard metal horseshoes.

### DRAWINGS

FIG. 1 is a side view of a horseshoe of the present invention.
1—Toe Clip
2—Ground Contact Surface

FIG. 2 is an angled back view of the horseshoe of FIG. 1
3—Through holes for hoof mounting via nails.
4—Hoof contact surface

FIG. 3 is the top view of the horse shoe of FIG. 1 and FIG. 2

FIG. 4 is the bottom view of the horseshoe of FIG. 1, FIG. 2, and FIG. 3
5—Recess for flush mounting of nail.

FIG. 5 is the side view of horseshoe of FIG. 1, FIG. 2, FIG. 3, and FIG. 4

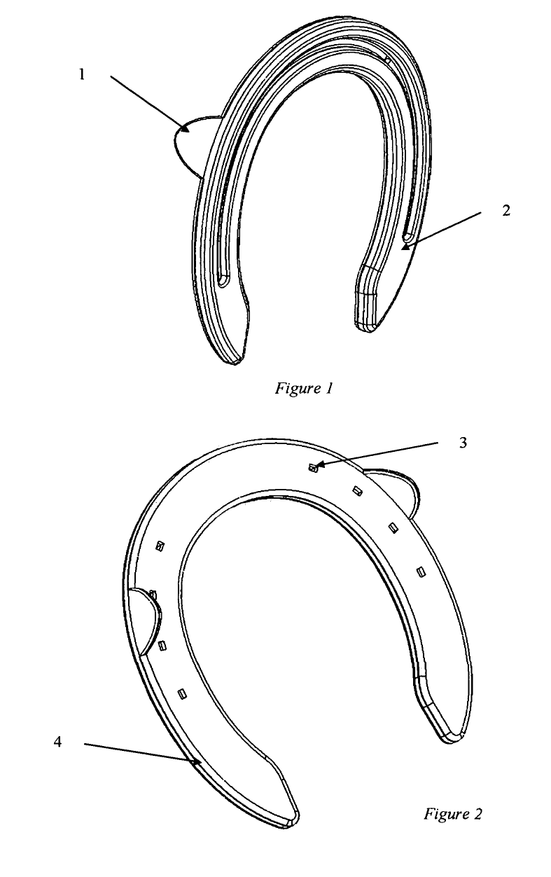

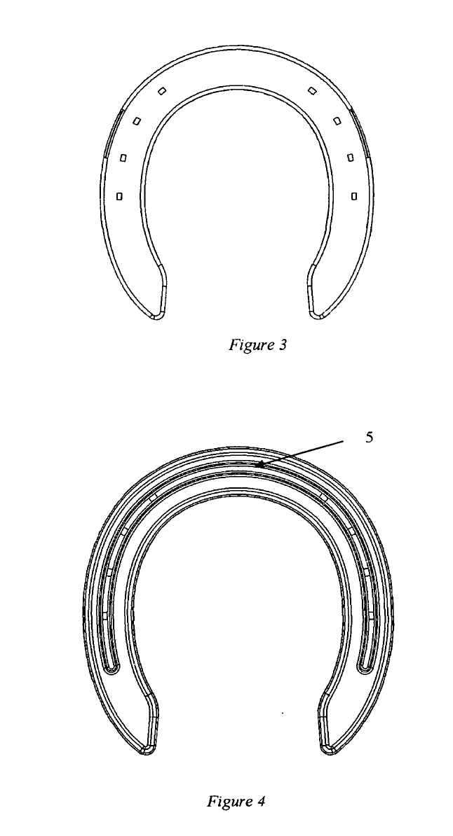

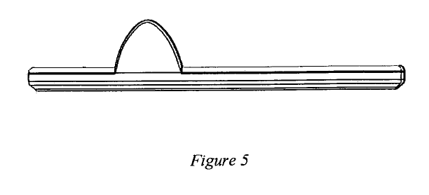

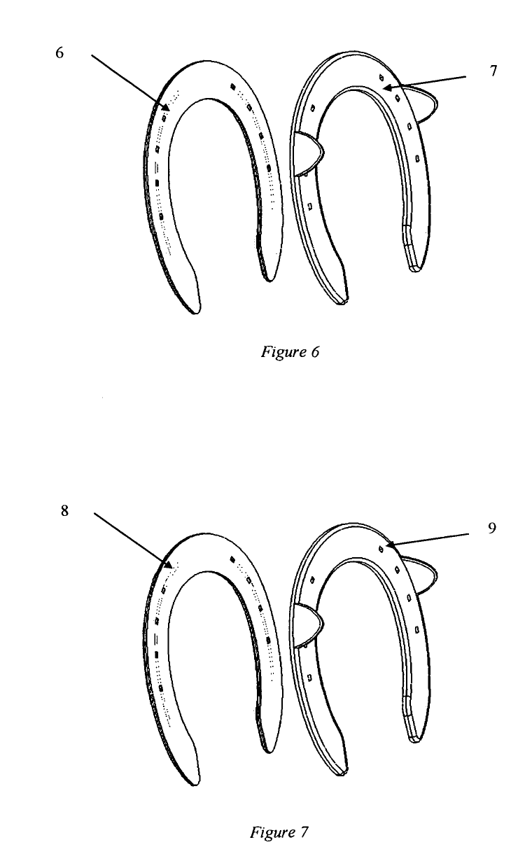

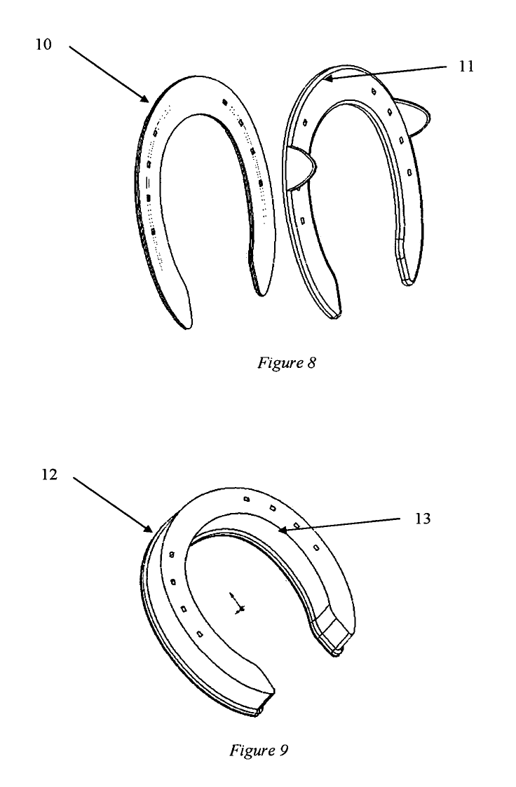

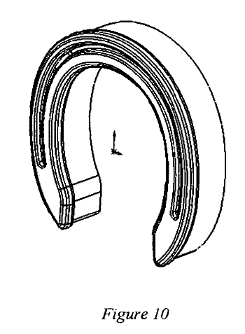

FIG. 6 is a side view of a horseshoe of the present invention with a polymer based external coating.
6—Polymer bottom coating
7—Fiber reinforced composite

FIG. 7 is a side view of a horseshoe of the present invention with an aluminum bottom plate containing cylindrical recessed threaded holes to mount calks, or spikes.
8—Aluminum.
9—Fiber reinforced composite

FIG. 8 is a side view of a horseshoe of the present invention with a top plate containing hollow rectangular extrusions.
10—Fiber reinforced composite.
11—Aluminum.

FIG. 9 is a top view of a horseshoe of the present invention constructed with an extruded polymer layer on the top of the horseshoe.
12—Fiber reinforced Polymer
13—Polymer for corrective shoeing

FIG. 10 is a bottom view of a horseshoe of the present invention constructed with an extruded polymer layer on the top of the horseshoe.

The invention claimed is:

1. A horseshoe to be affixed to the horses hoof in contact with the hoof; composed of a fiber reinforced polymer composite. Reinforcement material is not limited to but containing a high percent by volume of Carbon fiber, Keviar, Carbon fiber-Kevlar hybrid fabric, and Dynel fabric impregnated into but not limited to a polymer based matrix.

2. The horseshoe of claim 1, produced by a method of vacuum molding, where by said horseshoe is created from existing known universal horseshoe sizes. Utilizing the set dimensions from each universal size horseshoe individualy. Corresponding molds for manufacturing can be produced. Said horseshoe designs can be produced from but not limited to positive imprint mold, negative imprint mold, and two sided mold. Molds can be created from but not limited to polymer, clay, plaster and metal.

3. The horseshoe of claim 1, whereby custom sizes can be produced. Custom sizing can be produced for a specific hoof and or horse by utilizing but not limited to three dimensional imaging, direct imprinting into a mold. Data obtained from three dimensional imaging will be converted to render a mold.

4. A horseshoe of claim 1, further comprising reinforcement material in distinct layers and orientations relative to each other, to increase overall performance and wear.

5. A horseshoe of claim 1, further comprising a polymer based outer coating/layer to decrease wear, increase friction on hard terrain and decrease overall impact forces experienced by the horse.

6. A horseshoe of claim one, further comprising an extruded polymer layer existing on the top of the horseshoe. Whereby, said polymer layer may be removed by will by installer to achieve corrective angle changes.

7. A horseshoe of claim 1, further comprised of clips adhered to the front of the horseshoe comprised of but not limited to metal and composite material, to prevent the shifting of the shoe.

8. A horseshoe of claim 1, further comprising an aluminum bottom plate containing threaded cylindrical extrusions for the attachment of caulks or for an addition of a polymer based pad.

9. A horseshoe of claim 1, further comprising an aluminum backing plate containing hallow rectangular extrusions for the insertion of nails.

10. A horseshoe of claim 1, further comprising an internal or external honey comb structure composed of but not limited to a polymer, or elastomer construction.

11. A horseshoe of claim 1, further comprising internal and external based data acquisition sensors, incorporating but not limited to the use of piezoelectric materials.

12. A horseshoe of claim 1, further comprising an attached extruded front lip, composed of but not limited to metal, polymer, ceramic, composite structure.
